(19) United States
(12) Patent Application Publication
(10) Pub. No.: US 2013/0096832 A1
(43) Pub. Date: Apr. 18, 2013

(54) METHOD AND SYSTEM FOR PARTITIONING FARMING FIELD

(71) Applicants: Electronics and Telecommunications Research In, Daejeon (KR); Dongaone Co., Ltd., Seoul (KR)

(72) Inventor: Jun Wook LEE, Chungcheongbuk-do (KR)

(73) Assignees: DONGAONE CO., LTD., Seoul (KR); ELECTRONICS AND TELECOMMUNICATIONS RESEARCH INSTITUTE, Daejeon (KR)

(21) Appl. No.: 13/653,482

(22) Filed: Oct. 17, 2012

(30) Foreign Application Priority Data
Oct. 18, 2011 (KR) 10-2011-0106540
Jun. 25, 2012 (KR) 10-2012-0068157

(51) Int. Cl. G06F 19/00

(52) U.S. Cl. 702/5

(57) ABSTRACT

A farming field partition system calculates a cumulative solar radiation amount according to altitude at each position of a farming field using information of a shaded area and an unshaded area of the farming field at a specific time, groups the farming field based on a cumulative solar radiation amount according to a calculated altitude at a specific time at each position of the farming field, and visually displays a farming field partition according to a grouping result and displays the farming field partition on a screen.

### CROSS-REFERENCE TO RELATED APPLICATION

This application claims priority to and the benefit of Korean Patent Application Nos. 10-2011-0106540 and 10-2012-0068157 filed in the Korean Intellectual Property Office on Oct. 18, 2011 and Jun. 25, 2012, the entire contents of which are incorporated herein by reference.

### BACKGROUND OF THE INVENTION

(a) Field of the Invention

The present invention relates to a method and system for partitioning a farming field. More particularly, the present invention relates to a method and system for partitioning a farming field that divides partitions within the farming field using a wireless sensor network.

(b) Description of the Related Art

Nowadays, as wireless sensor network technology is applied to agricultural fields, technology that analyzes a growth environment of crops has been developed.

A wireless sensor network is installed at a specific position of an enormous farming field (cultivation field) to periodically collect weather and soil state information, and is used for analyzing collected information. Particularly, the information that is collected by the wireless sensor network is used for analyzing weather and soil state information of a microlevel within a farming field.

As a typical example, a vineyard or a corn farming field in the U.S.A. has an enormous size and thus shows different climate and soil information on a regional basis of a farming field, and because this is different from a physical partition, research on minute analysis using a wireless sensor network has been performed.

Many crops that are cultivated outdoors show a large difference in growth and production qualities according to solar energy, weather conditions, and soil conditions.

In general, in order to analyze a factor having an influence on growth and production quality, data on weather and soil conditions are generally used. However, when the data on weather and soil conditions are used together with topographical information of a farming field or are used for analysis together with a difference in solar energy of a farming field surface, growth management, harvesting, and farming field management of crops can be further improved.

An object of conventional farming field management using a wireless sensor network is to monitor a growth environment on a major position basis of a farming field through measured growth environment information, and the conventional farming field management does not consider topographical characteristics of the farming field. When a farming field is a hilly area instead of level land, a level of solar energy arriving at crops is different according to time (season). Because the sun generates and moves a shaded area according to a topographical characteristic in a daily level, an arrival amount of solar energy at each position according to a time zone of a day is also different. This has important ramifications in management of crops. This makes a difference of cultivation management in quality and management (pruning and irrigation) of crops.

That is, because an irrigation amount on a cultivation partition basis, crop management such as pruning, a harvesting time, and working time schedule are changed according to solar energy sequentially arriving at a surface of the earth and a climate condition, it is necessary to manage a farming field in consideration of topographical characteristics of the farming field.

### SUMMARY OF THE INVENTION

The present invention has been made in an effort to provide a method and system for partitioning a farming field having advantages of effectively partitioning the farming field in consideration of topographical characteristics of the farming field.

An exemplary embodiment of the present invention provides a farming field partition system. The farming field partition system includes a farming field analysis device and a farming field display device. A farming field analysis device groups a farming field using topographical characteristics of the farming field and an incident angle of the sun at a time when a request to partition the farming field is given and generates farming field partition information according to grouping. The farming field display device visually displays farming field partition information that is grouped at the time.

The farming field analysis device may include a shaded area analysis unit and a grouping operation unit. The shaded area analysis unit may divide the farming field into a shaded area and an unshaded area using topographical characteristics of the farming field and an incident angle of the sun at the time. The grouping operation unit may calculate a cumulative solar radiation amount according to altitude at each position of the farming field using a cumulative solar radiation amount at the time and a shaded area and an unshaded area of the farming field, and group the farming field based on a cumulative solar radiation amount according to altitude at each position of the farming field.

The farming field analysis device may further include an incident angle calculator that calculates a sequential incident angle of the sun, and the shaded area analysis unit may divide the farming field into a shaded area and an unshaded area using three-dimensional topographical information of the farming field and the incident angle of the sun.

The farming field analysis device may further include a solar radiation amount analysis unit that receives a solar radiation amount data of the farming field through a plurality of sensor nodes that are installed in the farming field, and that accumulates the solar radiation amount data on a time basis.

The farming field display device may include a sensing data receiving unit and a visualization unit. The sensing data receiving unit may receive sensing data through a plurality of sensor nodes that are installed in the farming field. The visualization unit may visually display the sensing data in a partition area of a visualized farming field according to the farming field partition information.

The farming field display device may further include a position data receiving unit that acquires present position data of a spot worker, wherein the visualization unit may visually display the spot worker's position in a partition area of the visually displayed farming field.

Another embodiment of the present invention provides a method of partitioning a farming field in a farming field analysis device. The method includes: receiving a request for partitioning the farming field at a first time from a farming field display device; determining an incident angle of the sun at the first time; and grouping the farming field using the incident angle of the sun and topographical information of the farming field at the first time.

The grouping of the farming field may include: dividing the farming field into a shaded area and an unshaded area using an incident angle of the sun and topographical information of the farming field at the first time; calculating a cumulative solar radiation amount according to altitude at each position of the farming field using information of the shaded area and the unshaded area; and grouping the farming field at the first time based on a cumulative solar radiation amount according to altitude at each position of the farming field.

The calculating of a cumulative solar radiation amount may include: collecting solar radiation amount data of the farming field; calculating a cumulative solar radiation amount of the first time using the collected solar radiation amount data; and calculating a cumulative solar radiation amount according to altitude at each position of the farming field using the cumulative solar radiation amount of the first time and information of the shaded area and the unshaded area.

### BRIEF DESCRIPTION OF THE DRAWINGS

FIG. 1 is a diagram illustrating a farming field partition system according to an exemplary embodiment of the present invention.

FIG. 2 is a block diagram illustrating a configuration of a farming field display device that is shown in FIG. 1.

FIG. 3 is a block diagram illustrating a configuration of a farming field analysis device that is shown in FIG. 1.

FIG. 4 is a flowchart illustrating operation of the farming field display device that is shown in FIG. 2.

FIG. 5 is a flowchart illustrating operation of a farming field analysis device that is shown in FIG. 3.

FIG. 6 is a flowchart illustrating operation of a shaded area analysis unit that is shown in FIG. 3.

FIG. 7 is a flowchart illustrating operation of a grouping operation unit that is shown in FIG. 3.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and system for partitioning a farming field according to an exemplary embodiment of the present invention will be described in detail with reference to the drawings.

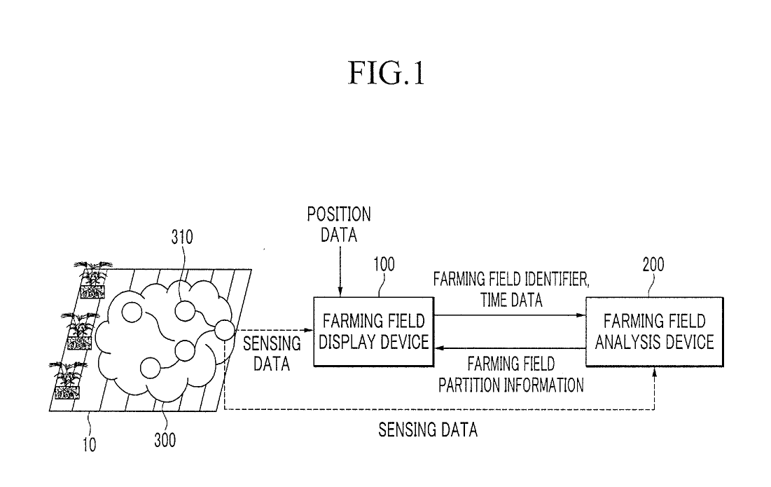

FIG. 1 is a diagram illustrating a farming field partition system according to an exemplary embodiment of the present invention.

Referring to FIG. 1, the farming field partition system includes a farming field display device 100, a farming field analysis device 200, and a sensor network 300.

The farming field display device 100 transmits and receives information to and from the farming field analysis device 200. Here, the information includes information that is related to partitioning of a farming field.

The farming field display device 100 is carried by a spot worker in a farming field 10 where crops are cultivated and transmits and receives information to and from the farming field analysis device 200 through a transmission network such as a communication network.

In order to manage crops of the farming field 10, the sensor network 300 is installed in the farming field 10 and includes a plurality of sensor nodes 310.

The plurality of sensor nodes 310 are each installed at a predetermined position within the farming field 10, they sense corresponding data at the installed position, and they transmit the sensing data together with position data of a corresponding sensor node 310 to the farming field display device 100.

The sensing data may include a solar radiation amount and environment information such as temperature, humidity, and illumination. For this purpose, each sensor node 310 includes a sensor (not shown) that measures a solar radiation amount. Further, each sensor node 310 may further include sensors that measure each environment information factor such as a temperature, humidity, and illumination.

The sensor node 310 transmits solar radiation amount data of the sensing data to the farming field analysis device 200.

The farming field display device 100 receives an input of a farming field identifier that can identify a farming field and condition data such as time data from a spot worker, and transmits condition data that receives an input from the spot worker to the farming field analysis device 200, thereby requesting to partition the farming field.

The farming field display device 100 may receive an input of a farming field identifier from the spot worker, or a farming field identifier may be extracted using present position information of the spot worker.

The farming field analysis device 200 collects solar radiation amount data of the farming field 10 from the sensor node 310, and accumulates and manages the collected solar radiation amount data.

The farming field analysis device 200 determines solar radiation amount data, three-dimensional topography information, and sun altitude information at a corresponding time and a corresponding farming field based on a farming field identifier and time data that is received from the farming field display device 100.

The farming field analysis device 200 groups a corresponding farming field and partitions the corresponding farming field using solar radiation amount data, three-dimensional topography information, and sun altitude information at the corresponding time and the corresponding farming field. The farming field analysis device 200 transmits farming field partition information to the farming field display device 100.

The farming field display device 100 visually displays a farming field partition using the farming field partition information that is received from the farming field analysis device 200, and displays the partitioned farming field on a screen in order for a spot worker to view it. In this case, the farming field display device 100 displays sensing data at the partitioned farming field based on position data of the sensor node 310. That is, sensing data is displayed in a partitioned area according to farming field partition information, and the spot worker may determine this through a screen. Further, the farming field display device 100 may display the spot worker's position at a partitioned farming field based on a present position of the spot worker.

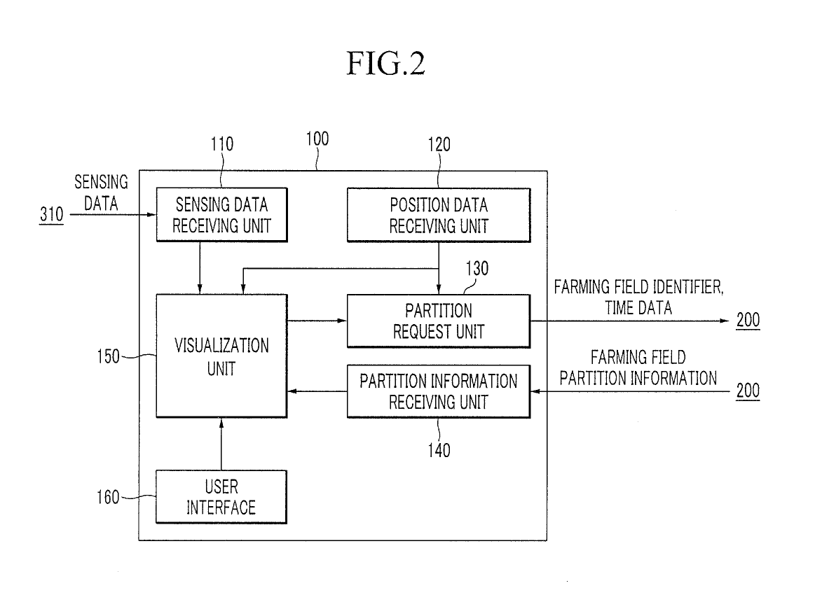

FIG. 2 is a block diagram illustrating a configuration of a farming field display device that is shown in FIG. 1.

Referring to FIG. 2, the farming field display device 100 includes a sensing data receiving unit 110, a position data receiving unit 120, a partition request unit 130, a partition information receiving unit 140, and a visualization unit 150. Further, the farming field display device 100 may further include a user interface 160.

The sensing data receiving unit 110 receives sensing data from the sensor node 310.

The position data receiving unit 120 acquires present position data according to movement of a spot worker, i.e., the farming field display device 100. The position data receiving unit 120 may acquire present position data of the spot worker based on a signal that is provided from, for example, a GPS apparatus, and acquire present position data of the spot worker from a separate apparatus that calculates a present position of the spot worker based on a signal that is provided from the GPS apparatus.

When the partition request unit 130 receives a request for partitioning of the farming field from the spot worker, the partition request unit 130 sends a request for farming field partitioning to the farming field analysis device 200. The farming field partition request may include condition data including a farming field identifier and time data necessary for the farming field partition request.

If only time data is included in the farming field partition request, the partition request unit 130 extracts a farming field identifier based on present position data of the spot worker and transmits the extracted farming field identifier and time data to the farming field analysis device 200, thereby requesting to partition the farming field.

The partition information receiving unit 140 receives farming field partition information from the farming field analysis device 200 and transfers the received farming field partition information to the visualization unit 150.

When a farming field partition request is received through the user interface 160, the visualization unit 150 transfers the farming field partition request to the partition request unit 130.

The visualization unit 150 partitions a farming field using farming field partition information that is received from the farming field analysis device 200 and visually displays the partitioned farming field, thereby displaying the partitioned farming field on a screen in order for the spot worker to view the partitioned farming field. The visualization unit 150 displays sensing data in the partitioned farming field based on position data of the sensor node 310. The visualization unit 150 displays the spot worker's position in a partitioned farming field based on present position data of the spot worker. In this case, the visualization unit 150 visually displays a partitioned farming field according to visualization form information that is input by the spot worker through the user interface 160. The visualization form information may include information about whether to visually display the farming field partition as a two-dimensional form or a three-dimensional form, and may include color information of a partitioned area or a kind of sensing data to visually displays.

The user interface 160 provides an interface with a spot worker, receives input of data such as a farming field identifier or time data and visualization form information from the spot worker, and transfers the data to the visualization unit 150. The user interface 160 may support various input methods from the spot worker. For example, the user interface 160 may support both input through a keyboard and input through a microphone.

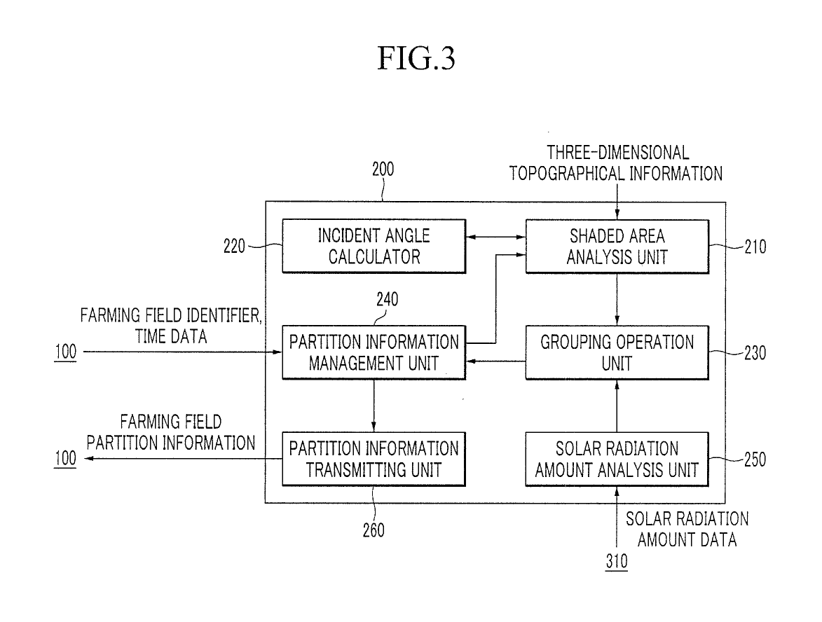

FIG. 3 is a block diagram illustrating a configuration of a farming field analysis device that is shown in FIG. 1.

Referring to FIG. 3, the farming field analysis device 200 includes a shaded area analysis unit 210, an incident angle calculator 220, a grouping operation unit 230, a partition information management unit 240, a solar radiation amount analysis unit 250, and a partition information transmitting unit 260.

The shaded area analysis unit 210 analyzes a shaded area and an unshaded area of the farming field 10 corresponding to a farming field identifier, and divides the shaded area and the unshaded area at a corresponding time according to the farming field identifier and time data.

The shaded area analysis unit 210 analyzes a shaded area and an unshaded area using a sunlight arrival angle (hereinafter referred to as an “incident angle”) from the sun to a surface of the earth at a corresponding time at the corresponding farming field 10 that is calculated by the incident angle calculator 220.

For this purpose, when the shaded area analysis unit 210 receives a farming field identifier and time data from the partition information management unit 240, the shaded area analysis unit 210 transfers a position of the farming field 10 corresponding to the farming field identifier and time data to the incident angle calculator 220.

The incident angle calculator 220 calculates an incident angle of the sun according to a specific date, time, and position. The incident angle calculator 220 may be an electronic sundial.

When the incident angle calculator 220 receives a position of the farming field 10 and time data from the shaded area analysis unit 210, the incident angle calculator 220 calculates an incident angle of the sun corresponding thereto and transfers the incident angle to the shaded area analysis unit 210.

The solar radiation amount analysis unit 250 receives solar radiation amount data that is sensed at the corresponding farming field 10 from the sensor node 310. The solar radiation amount analysis unit 250 accumulates and manages on a time basis solar radiation amount data that is sensed at the corresponding farming field 10 from the sensor node 310.

The grouping operation unit 230 is a module that performs sequential dynamic partitioning of the farming field 10. The grouping operation unit 230 performs a grouping operation at a corresponding position of the farming field 10 based on an analysis result of a shaded area of a corresponding time and a corresponding farming field 10 from the shaded area analysis unit 210 and solar radiation amount data that has been accumulated until the corresponding time from the solar radiation amount analysis unit 250.

The grouping operation unit 230 transfers farming field partition information according to a grouping operation result to the partition information management unit 240.

When the partition information management unit 240 receives a farming field partition request from the farming field display device 100, the partition information management unit 240 transfers a farming field identifier and position data to the shaded area analysis unit 210.

When the partition information management unit 240 receives farming field partition information by the grouping operation unit 230, the partition information management unit 240 stores and manages the farming field partition information and transfers the farming field partition information corresponding to a farming field partition request to the partition information transmitting unit 260.

If time data that is included in a farming field partition request corresponds to previous data based on a present time, the partition information management unit 240 searches for farming field partition information about a farming field identifier and time data, and if corresponding farming field partition information does not exist, the partition information management unit 240 transfers a farming field identifier and time data to the shaded area analysis unit 210, thereby partitioning the farming field. Further, if time data that is included in a farming field partition request does not correspond to previous data based on a present time, the partition information management unit 240 transfers a farming field identifier and time data to the shaded area analysis unit 210, thereby partitioning the farming field.

The partition information transmitting unit 260 transmits farming field partition information to the farming field display device 100.

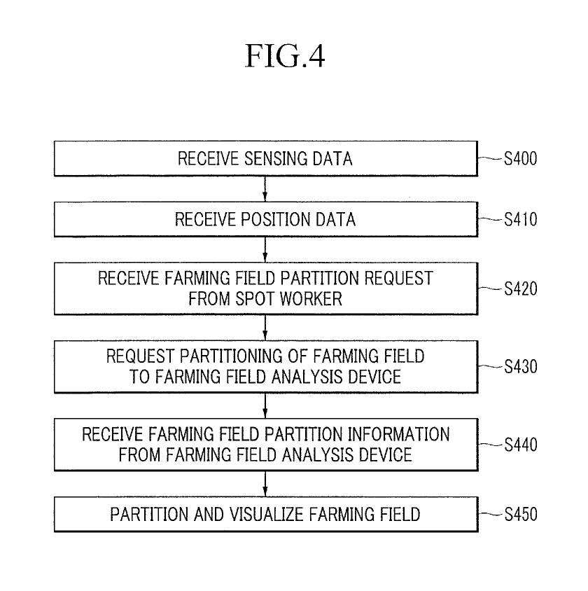

FIG. 4 is a flowchart illustrating operation of the farming field display device that is shown in FIG. 2.

Referring to FIG. 4, the sensing data receiving unit 110 receives sensing data from the sensor node 310 (S400), and the position data receiving unit 120 receives position data of a spot worker (S410).

When the partition request unit 130 receives a farming field partition request including a farming field identifier and time data from a spot worker (S420), the partition request unit 130 requests partitioning of the farming field by the farming field analysis device 200 (S430).

The partition information receiving unit 140 receives farming field partition information about a farming field partition request from the farming field analysis device 200 (S440).

The visualization unit 150 partitions and visually displays a farming field using farming field partition information about a farming field partition request (S450). In this case, the visualization unit 150 may display sensing data in a partitioned area and display the spot worker's position based on a present position of the spot worker.

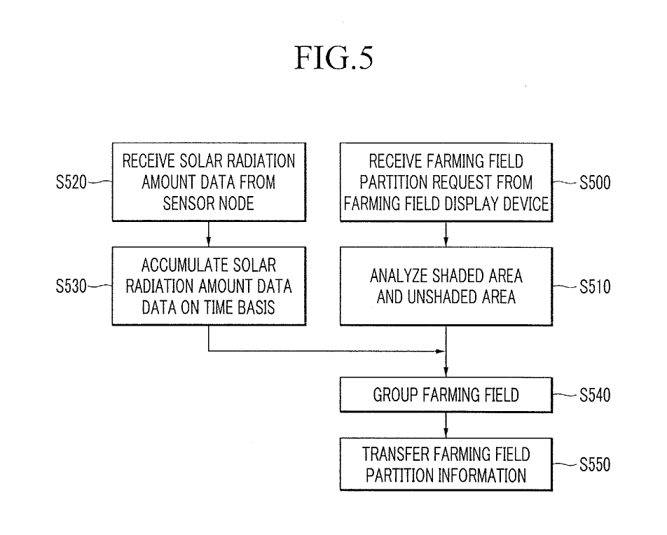

FIG. 5 is a flowchart illustrating operation of a farming field analysis device that is shown in FIG. 3.

Referring to FIG. 5, when the partition information management unit 240 receives a farming field partition request from the farming field display device 100 (S500), the partition information management unit 240 transfers a farming field identifier and time data to the shaded area analysis unit 210.

The shaded area analysis unit 210 analyzes a shaded area and an unshaded area at a corresponding time and the farming field 10 according to a farming field identifier and time data (S510), and transfers an analysis result to the grouping operation unit 230.

When the solar radiation amount analysis unit 250 receives solar radiation amount data that is sensed at a corresponding farming field 10 from the sensor node 310 (S520), the solar radiation amount analysis unit 250 accumulates and manages the sensed solar radiation amount data on a time basis at each position (S530).

The grouping operation unit 230 groups the corresponding farming field 10 based on an analysis result of a shaded area of a corresponding time and the corresponding farming field 10 from the shaded area analysis unit 210 and solar radiation amount data that has been accumulated until the corresponding time from the solar radiation amount analysis unit 250 (S540).

The grouping operation unit 230 transfers farming field partition information according to a grouping result of the farming field 10 to the partition information management unit 240.

The partition information management unit 240 transmits the farming field partition information to the farming field display device 100 (S550).

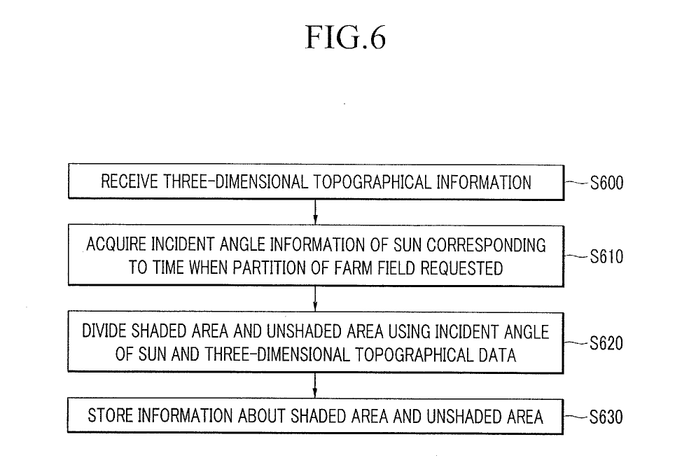

FIG. 6 is a flowchart illustrating operation of a shaded area analysis unit that is shown in FIG. 3.

Referring to FIG. 6, the shaded area analysis unit 210 receives a farming field identifier when the farming field display device 100 requests partitioning of a farming field and time data through the partition information management unit 240.

The shaded area analysis unit 210 receives three-dimensional topographical information constituting latitude, longitude, and altitude of the farming field 10 corresponding to the received farming field identifier (S600).

The shaded area analysis unit 210 acquires incident angle information of the sun corresponding to the received time data (S610). In this case, the shaded area analysis unit 210 requests an incident angle of the sun by transferring time data to the incident angle calculator 220, receives an incident angle of the sun according to a corresponding time that is calculated by the incident angle calculator 220, and thus acquires incident angle information of the sun corresponding to the received time data.

The shaded area analysis unit 210 analyzes a shaded area and an unshaded area of the corresponding farming field 10 at a corresponding time using an incident angle of the sun and three-dimensional topographical data of the farming field 10, and divides the shaded area and the unshaded area (S620).

The shaded area analysis unit 210 stores information about a shaded area and an unshaded area of the corresponding farming field 10 at the corresponding time (S630).

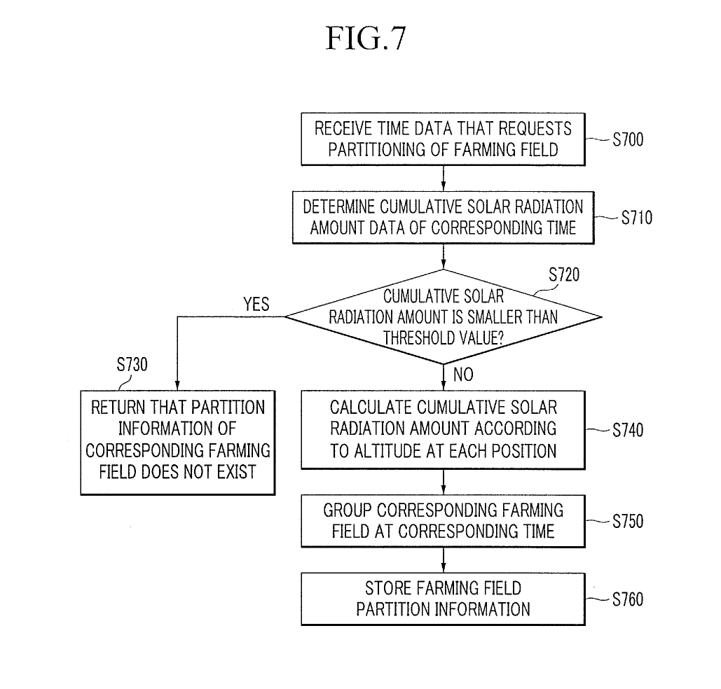

FIG. 7 is a flowchart illustrating operation of the grouping operation unit that is shown in FIG. 3.

Referring to FIG. 7, the grouping operation unit 230 receives time data when the farming field display device 100 requests partitioning of a farming field (S700).

The grouping operation unit 230 determines cumulative solar radiation amount data of a corresponding time (S710).

The grouping operation unit 230 determines whether a cumulative solar radiation amount of a corresponding time is smaller than a threshold value (S720).

If a cumulative solar radiation amount of a corresponding time is smaller than a threshold value, the grouping operation unit 230 cannot partition a farming field. Therefore, if a cumulative solar radiation amount of a corresponding time is smaller than a threshold value, the grouping operation unit 230 returns a finding that partition information does not exist (S730).

If a cumulative solar radiation amount of a corresponding time is equal to or larger than a threshold value, the grouping operation unit 230 calculates a cumulative solar radiation amount according to an altitude at each position of the farming field 10 using a cumulative solar radiation amount of the corresponding time and information of a shaded area and an unshaded area of the corresponding farming field 10 (S740). That is, a cumulative solar radiation amount that is calculated from solar radiation amount data that is sensed by the sensor node 310 that is installed at a random position may be changed according to altitude. Therefore, the grouping operation unit 230 calculates a cumulative solar radiation amount according to altitude. Further, in order to calculate a cumulative solar radiation amount at each position of the farming field 10, a large number of sensor nodes 310 are necessary. Therefore, the grouping operation unit 230 may calculate a cumulative solar radiation amount at another adjacent position using solar radiation amount data that is sensed by the sensor node 310 that is installed at a random position. Thereby, a smaller number of sensor nodes 310 may calculate a cumulative solar radiation amount at many positions.

The grouping operation unit 230 groups a corresponding farming field 10 at a corresponding time based on a cumulative solar radiation amount according to altitude at each position of the farming field 10 (S750). For example, the grouping operation unit 230 may perform grouping based on similarity of cumulative solar radiation amounts according to altitude at each position of the farming field 10.

The grouping operation unit 230 stores farming field partition information according to a grouping result (S760).

According to an exemplary embodiment of the present invention, at a place cultivating crops through a large scale farming field such as a grapevine, a corn, and a fruit tree, a farming field is dynamically partitioned at a desired time in consideration of together with a topographical characteristic of the farming field and a sunlight condition instead of fixedly dividing and managing, and the farming field that is dynamically partitioned at a desired time can be provided to a user. Further, a farming field is dynamically grouped and partitioned using a sequential solar radiation amount condition of the farming field and shaded area analysis in consideration of latitude, longitude, and altitude together, and the farming field partition information can be visually displayed to a user.

Because existing management using environment information sensing data such as soil and atmosphere cannot accurately grasp topographical characteristic differences according to cultivation position, it is difficult for the existing management to support determination of an intention for crop management. However, according to an exemplary embodiment of the present invention, because a grower can grasp farming field partition information that is dynamically partitioned through a farming field display device in real time, determination of a major intention such as cultivation and harvest of crops can be supported on a seasonal basis.

An exemplary embodiment of the present invention may not only be embodied through the above-described apparatus and/or method but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A farming field partition system comprising:
a farming field analysis device that groups a farming field using topographical characteristics of the farming field and an incident angle of the sun at a time when a request to partition the farming field is given and that generates farming field partition information according to grouping; and
a farming field display device that visually displays farming field partition information that is grouped at the time.

2. The farming field partition system of claim 1, wherein the farming field analysis device comprises:
a shaded area analysis unit that divides the farming field into a shaded area and an unshaded area using topographical characteristics of the farming field and an incident angle of the sun at the time; and
a grouping operation unit that calculates a cumulative solar radiation amount according to altitude at each position of the farming field using a cumulative solar radiation amount at the time and a shaded area and an unshaded area of the farming field, and that groups the farming field based on a cumulative solar radiation amount according to altitude at each position of the farming field.

3. The farming field partition system of claim 2, wherein the farming field analysis device further includes an incident angle calculator that calculates a sequential incident angle of the sun, and
the shaded area analysis unit divides the farming field into a shaded area and an unshaded area using three-dimensional topographical information of the farming field and the incident angle of the sun.

4. The farming field partition system of claim 2, wherein the farming field analysis device further comprises a solar radiation amount analysis unit that receives solar radiation amount data of the farming field through a plurality of sensor nodes that are installed in the farming field, and that accumulates the solar radiation amount data on a time basis.

5. The farming field partition system of claim 1, wherein the farming field display device comprises:
a sensing data receiving unit that receives sensing data through a plurality of sensor nodes that are installed in the farming field; and
a visualization unit that visually displays the sensing data in a partition area of a visualized farming field according to the farming field partition information.

6. The farming field partition system of claim 5, wherein the farming field display device further comprises a position data receiving unit that acquires present position data of a spot worker,
wherein the visualization unit visually displays the spot worker's position in a partition area of the visualized farming field.

7. The farming field partition system of claim 6, wherein the farming field display device is carried by the spot worker.

8. The farming field partition system of claim 5, wherein the farming field display device further includes a user interface that provides an interface with a spot worker.

9. A method of partitioning a farming field in a farming field analysis device, the method comprising:
receiving a request for partitioning the farming field at a first time from a farming field display device;
determining an incident angle of the sun at the first time; and
grouping the farming field using the incident angle of the sun and topographical information of the farming field at the first time.

10. The method of claim 9, wherein the grouping of the farming field comprises:
dividing the farming field into a shaded area and an unshaded area using the incident angle of the sun and topographical information of the farming field at the first time;
calculating a cumulative solar radiation amount according to an altitude at each position of the farming field using information of the shaded area and the unshaded area; and
grouping the farming field at the first time based on a cumulative solar radiation amount according to altitude at each position of the farming field.

11. The method of claim 10, wherein the calculating of a cumulative solar radiation amount comprises:
collecting solar radiation amount data of the farming field;
calculating a cumulative solar radiation amount of the first time using the collected solar radiation amount data; and
calculating a cumulative solar radiation amount according to altitude at each position of the farming field using the cumulative solar radiation amount of the first time and information of the shaded area and the unshaded area.

12. The method of claim 11, wherein the collecting of solar radiation amount data comprises receiving the solar radiation amount data through a plurality of sensor nodes that are installed in the farming field.

13. The method of claim 9, wherein the receiving of a request comprises receiving an identifier of the farming field and information of the first time.
